(19) United States
(12) Patent Application Publication
(10) Pub. No.: US 2026/0252837 A1
(43) Pub. Date: Aug. 27, 2026

(54) Biometric Multi-Account Transaction Card

(71) Applicant: Tywana Woodley, Philadelphia, PA (US)

(72) Inventor: Tywana Woodley, Philadelphia, PA (US)

(21) Appl. No.: 19/441,973

(22) Filed: Jan. 7, 2026

Related U.S. Application Data
(60) Provisional application No. 63/764,077, filed on Feb. 27, 2025.

(51) Int. Cl. G06K 19/07; G06K 19/077; G06Q 20/20; G06Q 20/32; G06Q 20/34; G06Q 20/40; G06V 40/13; G06V 40/16

(52) U.S. Cl. CPC G06K 19/0718; G06K 19/07773; G06Q 20/20; G06Q 20/3278; G06Q 20/3572; G06Q 20/40145; G06V 40/13; G06V 40/172; G06Q 2220/00

(57) ABSTRACT

A biometric multi-account transaction card and associated transaction system. The card includes a card body conforming to ISO/IEC 7810 ID-1, a fingerprint sensor configured to capture user biometric data, an optical element for facial-recognition or optical sensing, and an integrated circuit contact module for EMV communication is disclosed. A secure element stores a non-reversible biometric template and multiple tokenized payment credentials organized in credential slots. A microcontroller executes biometric-matching algorithms, account-selection logic, and generates EMV-compliant cryptograms, while an NFC antenna enables contactless operation. A cooperating point-of-sale terminal displays account options received from the card and can perform facial recognition for multi-factor authentication. Upon successful authentication, the card transmits a tokenized payment credential corresponding to a selected account.

### CROSS-REFERENCE TO RELATED APPLICATION

The present application claims priority to, and the benefit of, U.S. Provisional Application No. 63/764,077 which was filed on Feb. 27, 2025 and is incorporated herein by reference in its entirety.

### FIELD OF THE INVENTION

The present invention generally relates to financial transaction devices. More specifically, the present invention relates to a biometric multi-account transaction card incorporating fingerprint authentication, multi-factor security features, and storage of multiple tokenized financial accounts. The invention comprises a multi-component card assembly including a card body having an embedded fingerprint sensor, an integrated circuit contact module, and an optical element configured for facial-recognition interaction at a point-of-sale terminal. Internally, the card includes a secure element for storing non-reversible biometric templates, authentication keys, and multiple tokenized account credentials, as well as a microcontroller and NFC antenna configured to execute biometric matching and EMV transaction protocols. Accordingly, the present disclosure makes specific reference thereto. Nonetheless, it is to be appreciated that aspects of the present invention are also equally applicable to other like applications, devices, and methods of manufacture.

### BACKGROUND

By way of background, traditional payment cards, including credit and debit cards, are widely used for consumer transactions but are susceptible to numerous security vulnerabilities. Conventional magnetic-stripe and chip-based cards can be compromised through skimming devices, data breaches, and other unauthorized acquisition of cardholder information, leading to identity theft, bank fraud, and unauthorized retail purchases. Moreover, because the conventional cards typically rely on printed account numbers and static credentials, a stolen or lost card can be misused before the cardholder or financial institution becomes aware of the breach.

Consumers often carry multiple physical cards to access different financial accounts or reward programs. This increases the likelihood of misplacement, loss, or theft, and complicates card management. As the number of payment instruments grows, so does the risk of exposure to fraudulent activity, creating a need for improved mechanisms that enhance transaction security and reduce reliance on multiple vulnerable physical cards.

Therefore, there exists a long-felt need in the art for an improved financial transaction card that overcomes the vulnerabilities of conventional credit and debit cards. Also, there is a long-felt need for a payment instrument capable of securely consolidating multiple financial accounts into a single device, thereby reducing the risk of loss or theft associated with carrying multiple cards. Additionally, there exists a need for a transaction card that verifies the identity of the rightful cardholder before releasing any payment credentials. Moreover, there is a need for a card system that incorporates biometric authentication and multi-factor security without requiring users to rely on external mobile devices or additional hardware. Finally, there is a need for a system that maintains compatibility with existing POS infrastructure while providing significantly enhanced protection against fraudulent transactions.

The subject matter disclosed and claimed herein, in one embodiment, comprises a biometric multi-account transaction card designed to provide secure, consolidated, and user-authenticated access to multiple financial accounts. The transaction card includes a card body conforming to ISO/IEC 7810 ID-1 dimensions, formed from durable polymeric materials such as PVC, PC, ABS, or PETG. A fingerprint sensor is configured to capture biometric data from an authorized user, along with an integrated circuit contact module operable under ISO/IEC 7816 and EMV standards. The card further includes an optical element or imaging aperture for supporting facial-recognition interactions when used in conjunction with a compatible point-of-sale terminal. Internally, the card incorporates a secure element for storing non-reversible biometric templates, authentication keys, and multiple tokenized payment credentials organized into isolated credential slots. A microcontroller executes biometric-matching algorithms, account-selection logic, and EMV-compliant transaction protocols, while an NFC antenna supports contactless communication and power harvesting.

In one embodiment, the biometric transaction card incorporates enhanced operational features such as dynamic account labeling, cryptographically generated EMV transaction values, and multi-factor authentication via interaction with a POS terminal equipped with a facial-recognition module.

In this manner, the biometric multi-account transaction card of the present invention overcomes long-standing deficiencies associated with conventional financial cards by providing a secure, biometric-authenticated, and account-consolidating payment solution. The invention enables users to access multiple financial accounts from a single card, thereby reducing card clutter and minimizing the likelihood of loss or theft. The card uses fingerprint authentication and facial-recognition verification such that only the rightful cardholder can activate or use the card, thereby significantly reducing fraud risk. The integration of a secure element and EMV-compliant cryptographic protocols improves transaction security through dynamic credential generation.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a biometric multi-account transaction card constructed with a card body conforming to the ISO/IEC 7810 ID-1 format. The card incorporates a fingerprint sensor capable of capturing a user's fingerprint and an integrated circuit contact module suitable for EMV and ISO/IEC 7816 communication. An optical element is further included to support facial-recognition or optical-detection functions. Internally, the card houses a secure element for storing a non-reversible biometric template and multiple tokenized payment credentials, as well as a token memory bank that organizes these credentials into separate slots. A microcontroller executes biometric matching, account-selection logic, and EMV transaction functions, and an NFC antenna enables contactless operation. The microcontroller authenticates the user and release a tokenized payment credential corresponding to a selected account when biometric authentication is successful.

In another embodiment, the invention provides a transaction system comprising both a biometric multi-account transaction card and a cooperating point-of-sale (POS) terminal. The card includes a fingerprint sensor, a secure element storing biometric templates and a plurality of tokenized credentials, a microcontroller for authentication and account-label transmission, and an NFC antenna for wireless communication. The POS terminal includes a display that presents account options received from the card and a facial-recognition module that captures facial imagery of the user to support multi-factor authentication. The POS terminal additionally incorporates a contactless interaction region to communicate with the card. The POS terminal may receive user input selecting one of several accounts and then request a corresponding tokenized credential from the card after verifying that biometric authentication has been successfully completed.

In yet another aspect, the invention provides a method for operating a biometric multi-account transaction card. The method includes enrolling the card by capturing a fingerprint and storing a non-reversible biometric template in a secure element. The method further includes receiving card-account credentials for a financial account, generating a tokenized payment credential, and storing the credential in one of several credential slots. When the card is presented to a POS terminal, the method includes authenticating the user through fingerprint comparison and transmitting a tokenized payment credential associated with a selected account. The invention enables the card to securely support multiple accounts and selectively release payment credentials only after the user has been properly authenticated.

In still another aspect, the invention provides a non-transitory computer-readable medium storing instructions that control a microcontroller of a biometric transaction card. The instructions cause the card to capture fingerprint data, compare it against a stored non-reversible biometric template, and determine whether authentication is successful. Upon successful authentication, the card retrieves a tokenized payment credential, generates an EMV-compliant dynamic cryptogram, and transmits the cryptogram through NFC or EMV communication to a POS terminal. This enables secure, dynamic, and authenticated financial transactions.

In some embodiments, the fingerprint sensor used on the biometric transaction card includes capacitive, optical, or ultrasonic sensing technology (i.e., sensors) and is embedded flush with the surface of the card body. The sensor may range from 8 mm to 15 mm in its longest dimension, enabling it to be compact while still capable of capturing a high-quality biometric sample.

In one embodiment, the POS terminal is configured to require successful facial-recognition verification before requesting a tokenized payment credential from the card.

In some methods of operation, the card monitors failed biometric-authentication attempts and enters a security lockout state after a predetermined number of failures. Once triggered, the lockout disables the secure element and prevents EMV communication until the card is reset or reauthorized.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of biometric multi-factor transaction card configured for use in secure financial transactions;

FIG. 2 illustrates a schematic block diagram showing internal architecture of the biometric multi-account transaction card of the present invention in accordance with the disclosed structure;

FIG. 3 illustrates an exemplary point-of-sale (POS) terminal configured to interact with the biometric multi-account transaction card of the present invention;

FIG. 4 illustrates a flow chart depicting an enrollment and biometric-registration process for initializing the biometric multi-account transaction card of the present invention;

FIG. 5 illustrates a flow chart depicting an exemplary process for provisioning a new financial account onto the biometric multi-account transaction card in accordance with the disclosed structure;

FIG. 6 illustrates a flowchart depicting an exemplary transaction-interaction process between the biometric multi-account transaction card and a point-of-sale (POS) terminal;

FIG. 7 illustrates an exemplary security-response process implemented by the biometric multi-account transaction card in accordance with the disclosed structure; and

FIG. 8 illustrates a flowchart depicting a process for generating a tokenized payment credential and producing an EMV-compliant cryptogram during a transaction initiated by the biometric multi-account transaction card.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved financial transaction card that overcomes the vulnerabilities of conventional credit and debit cards. Also, there is a long-felt need for a payment instrument capable of securely consolidating multiple financial accounts into a single device, thereby reducing the risk of loss or theft associated with carrying multiple cards. Additionally, there exists a need for a transaction card that verifies the identity of the rightful cardholder before releasing any payment credentials. Moreover, there is a need for a card system that incorporates biometric authentication and multi-factor security without requiring users to rely on external mobile devices or additional hardware. Finally, there is a need for a system that maintains compatibility with existing POS infrastructure while providing significantly enhanced protection against fraudulent transactions.

The present invention, in one exemplary embodiment, is a method for operating a biometric multi-account transaction card. The method includes enrolling the card by capturing a fingerprint and storing a non-reversible biometric template in a secure element. The method further includes receiving card-account credentials for a financial account, generating a tokenized payment credential, and storing the credential in one of several credential slots. When the card is presented to a POS terminal, the method includes authenticating the user through fingerprint comparison and transmitting a tokenized payment credential associated with a selected account.

Reference will now be made in detail to the present preferred embodiments of the invention, examples of which are illustrated in the accompanying drawings. Wherever possible, the same reference numerals are used in the drawings and the description to refer to the same or like parts.

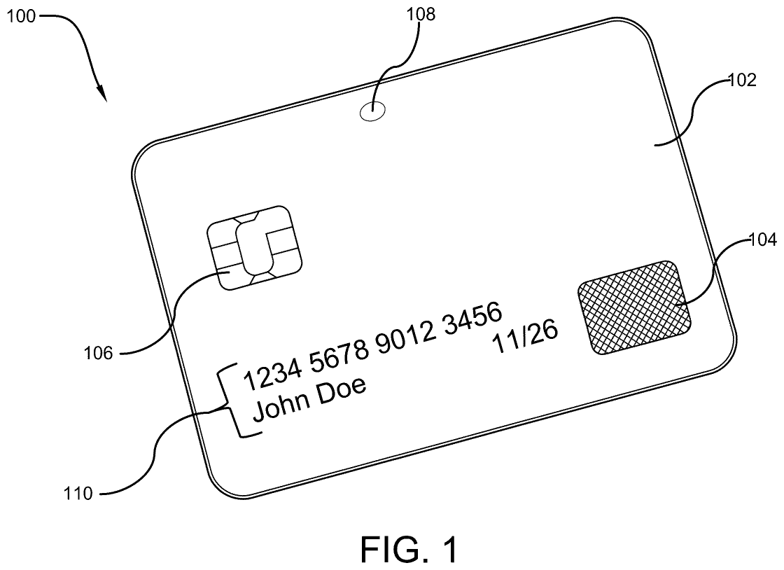

Referring initially to the drawings, FIG. 1 illustrates a perspective view of biometric multi-account transaction card of the present invention configured for use in secure financial transactions in accordance with the disclosed structure. The biometric multi-account transaction card 100 is configured for use in secure financial transactions and is designed to secure and simplify consumer credit usage. More specifically, the multi-factor transaction card 100 includes a generally rectangular card body 102 having rounded corners and conforming, in preferred embodiments, to the standard ISO/IEC 7810 ID-1 format. In the preferred embodiment, the card apparatus 100 has nominal dimensions of 85.60 mm×53.98 mm×0.76 mm. The card body 102 can be composed of one or more laminated layers of polyvinyl chloride (PVC), polycarbonate (PC), acrylonitrile butadiene styrene (ABS), polyethylene terephthalate glycol (PETG), or similar durable polymeric substrate materials.

The card body 102 has an embedded biometric fingerprint sensor 104. The fingerprint sensor 104 can be implemented using capacitive, optical, or ultrasonic sensing technology and is operable to capture a fingerprint image or template of an authorized user. In certain embodiments, the fingerprint sensor 104 can be embedded flush with the surface of the card body, can include a protective polymer overlayer, and can be sized between 8 mm and 15 mm on the longest dimension thereof.

An integrated circuit contact module 106, preferably conforming to ISO/IEC 7816 and EMV (Europay-Mastercard-Visa) specifications is included in the card body 102. The contact module 106 includes a plurality of conductive pads configured to communicate with point-of-sale (POS) terminals for power, data exchange, and cryptographic processing.

An imaging aperture or optical element 108 is configured for use in facial recognition, environmental light sensing, or other optical detection functions. The optical element 108 can be implemented as a miniature lens, photodiode assembly, camera sensor cover, or optical window through which a sub-surface imaging module views the user. In embodiments of the present invention which utilize facial recognition or authentication, the optical element or module 108 may capture facial features or perform liveness detection when the card is positioned near a compatible POS terminal. The aperture 108 may range from 1 mm to 4 mm in diameter, depending on sensor type.

The front surface of the card 100 further displays account information 110, including, in the illustrated embodiment, a primary account number, cardholder name, and expiration date (for example, “1234 5678 9012 3456”, “John Doe”, and “11/26”). The information 110 can be printed using inkjet, laser engraving, embossing, laser-etching, or metal foil transfer processes. In some embodiments, the information 110 can be omitted, partially hidden, tokenized, or displayed digitally for enhanced privacy.

The card 100 can be colored in any suitable manner, including solid tones, gradients, or graphical designs. In illustrative embodiments, the card may employ dark or metallic background coloration to provide contrast with functional components such as the fingerprint sensor 104 and the optical element or module 108. It should be understood that the placement, size, shape, and orientation of the modules illustrated in FIG. 1 are exemplary only and may be modified without departing from the inventive concepts disclosed herein.

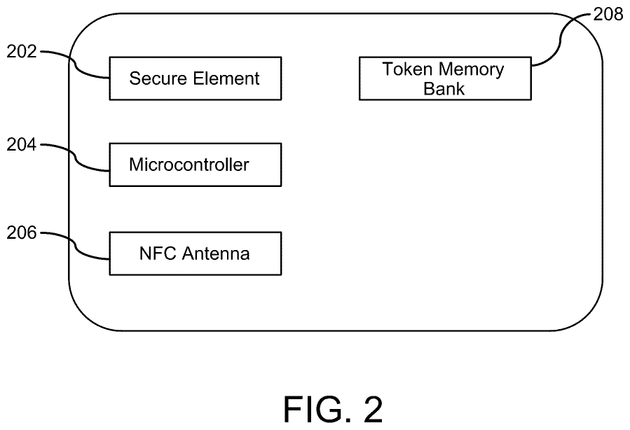

FIG. 2 illustrates a schematic block diagram showing internal architecture of the biometric multi-account transaction card of the present invention in accordance with the disclosed structure. The card body 102 (FIG. 1) includes a secure element (SE) 202. The secure element 202 is configured as a tamper-resistant integrated circuit to store biometric templates, tokenized payment credentials, and authentication keys. The secure element 202 can be implemented as a certified hardware security module (HSM), secure microcontroller, or Java Card-compliant secure IC. The secure element 202 preferably conforms to EMVCo and Common Criteria certification levels.

The card body 102 includes a token memory bank 208, which may comprise one or more regions of secure non-volatile storage used to hold tokenized representations of multiple financial accounts stored in the card apparatus 100. The token memory bank 208 can be logically partitioned to store a plurality of independent token slots corresponding to different credit cards, debit cards, loyalty accounts, or financial services associated with the user.

A microcontroller 204 in the form of an embedded processing unit is configured to execute biometric-matching algorithms, account-selection logic, and EMV transaction protocols. The microcontroller 204 can further operate as the control system responsible for managing communications between the secure element 202, the token memory bank 208, and external card-reader terminals as described later in the disclosure. In some embodiments, the microcontroller 204 can include a dedicated arithmetic logic unit (ALU), random-number generator (RNG), and low-power processing core.

The card apparatus 100 includes an NFC antenna 206. The NFC antenna 206 is formed as a conductive loop or planar antenna structure embedded in the card body 102. The antenna 206 is configured to support near-field communication (NFC), ISO/IEC 14443, and EMV contactless functionality. The antenna 206 provides wireless communication with point-of-sale terminals and may also serve as an inductive power-harvesting mechanism, supplying operational energy to the microcontroller 204 and secure element 202 during contactless transactions.

The secure element 202, token memory bank 208, microcontroller 204, and NFC antenna 206 can be implemented in a variety of configurations, including as a single integrated chip, as physically separate ICs connected by embedded conductive traces, or in hybrid arrangements using stacked or laminated component layers.

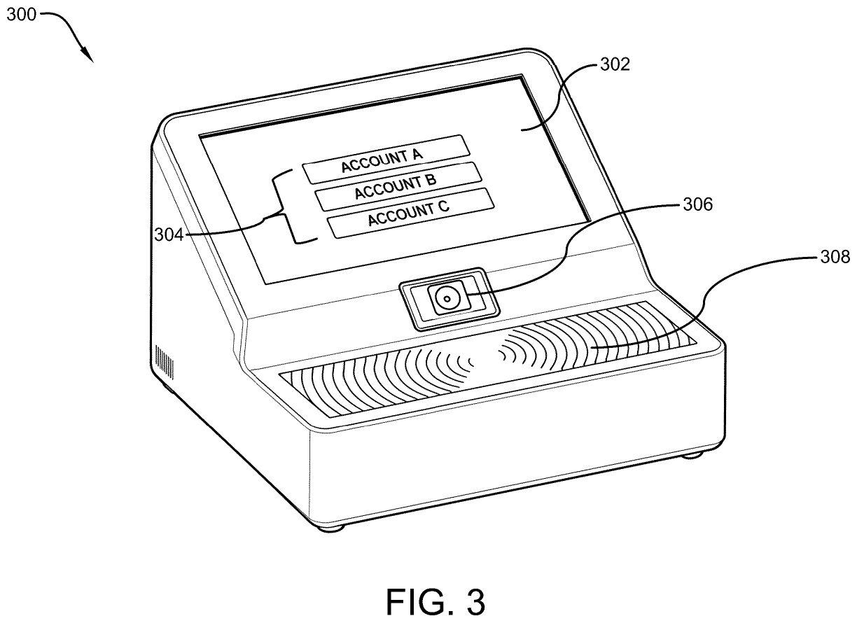

FIG. 3 illustrates an exemplary point-of-sale (POS) terminal configured to interact with the biometric multi-account transaction card of the present invention. The POS terminal 300 includes a housing that supports a display screen 302, which presents a graphical user interface for enabling selection among multiple payment accounts provisioned on the card apparatus 100. In the illustrated embodiment, the display screen 302 shows a set of selectable account options 304, exemplified as ACCOUNT A, ACCOUNT B, and ACCOUNT C, though any number and arrangement of accounts may be presented.

A facial-recognition module 306, which can include a camera, optical sensor array, or depth-sensing unit operable to acquire facial imagery of a user for multi-factor authentication, is included in the POS terminal 300. In various embodiments, the facial-recognition module 306 may communicate authentication status back to the POS software or directly to the transaction card.

A contactless interaction region 308 houses an NFC or RFID transceiver coil configured to wirelessly communicate with the card apparatus 100 during a payment transaction. The contactless interface 308 may supply inductive power to the card apparatus 100, exchange EMV contactless data, facilitate account-selection communication, and receive biometric-authentication confirmation from the card.

In use, the biometric transaction card 100 is presented by a user to the POS terminal 300, where the card apparatus 100 is positioned within the contactless interaction region 308 or can be inserted into a contact-based reader (not shown). Upon detecting the presence of the card, the terminal 300 activates the account-selection interface on the display screen 302, enabling the user to select one of the multiple payment accounts stored in the card's secure element. As the user makes a selection on the graphical interface 304, the card simultaneously performs on-card biometric authentication through the fingerprint sensor, such that only an authorized cardholder may initiate the transaction. In embodiments utilizing multi-factor verification, the facial-recognition module 306 acquires facial imagery of the user and transmits a verification result to the transaction controller within the POS terminal. Once the POS terminal receives both account-selection input and successful biometric verification, the terminal requests payment credentials from the card, and the card responds by generating and transmitting a dynamic cryptographic token corresponding to the selected account.

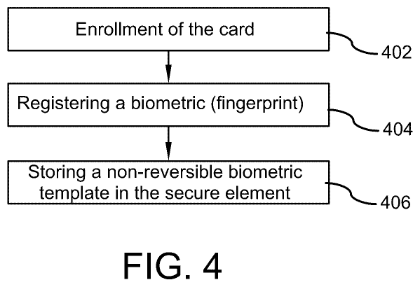

FIG. 4 illustrates a flow chart depicting an enrollment and biometric-registration process for initializing the biometric multi-account transaction card of the present invention. Initially, enrollment of the card is initiated (Step 402), which can be performed by an issuing bank, user device, or authorized provisioning terminal. During enrollment, the card is activated, placed into an initialization mode, and prepared to receive user-specific authentication data.

Then, the card apparatus registers a biometric (i.e., a fingerprint) (Step 404). A user may place a finger on the fingerprint sensor 104 integrated into the card. The sensor captures a high-resolution biometric sample suitable for template generation. The captured biometric data is processed by an onboard microcontroller or secure processing module to derive a mathematical representation of the user's fingerprint.

Thereafter, the card stores a non-reversible biometric template in the secure element (Step 406). The processed fingerprint data is converted into a non-reversible biometric template that cannot be reconstructed into the original fingerprint image. The template is securely written into a tamper-resistant memory area of the secure element, such that only the authorized user may subsequently authenticate and activate the card for transactions. Once the template is stored, the card exits enrollment mode and becomes locked to the registered biometric identity.

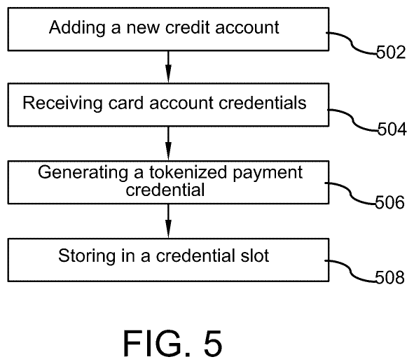

FIG. 5 illustrates a flow chart depicting an exemplary process for provisioning a new financial account onto the biometric multi-account transaction card in accordance with the disclosed structure. Initially, a user initiates adding a new credit account (Step 502). The initiation can occur through a mobile application, issuer interface, online banking platform, or in-person banking terminal configured to communicate with the card.

In step 504, the method proceeds with receiving card account credentials. The user may input card data manually, scan an existing physical card, or authenticate through a linked banking service. In certain embodiments, the card credentials can be transmitted directly from the issuing bank to the card 100 through secure communication channels.

Thereafter, a tokenized payment credential is generated (Step 506). The step includes replacing the actual card number and sensitive account details with a network-issued payment token and associated cryptographic keys. The resulting tokenized credential provides transaction functionality equivalent to the original account but without exposing the true primary account number, thereby enhancing security. It should be noted that in some embodiments, tokens may not be generated as per implementation and in such cases, actual card number and sensitive account details can be stored in the card apparatus 100.

At step 508, generated tokenized credential is securely written into one of a plurality of credential slots stored within the secure element of the transaction card. Each credential slot corresponds to a separate user financial account, enabling the card to securely maintain multiple tokenized accounts simultaneously. The stored credential may then be selected by the user during a payment transaction.

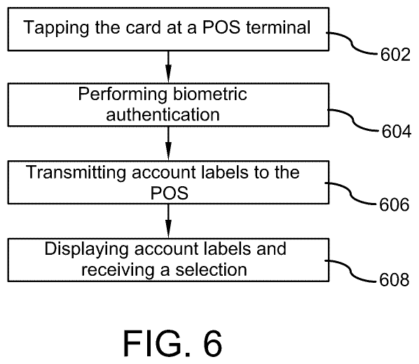

FIG. 6 illustrates a flowchart depicting an exemplary transaction-interaction process between the biometric multi-account transaction card and a point-of-sale (POS) terminal. Initially, a user initiates a payment transaction by tapping the card at a POS terminal (Step 602). In embodiments supporting contact-based EMV communication, the step may alternatively include inserting or swiping the card, although contactless interaction is preferred for rapid authentication and power harvesting.

Then, the card performs biometric authentication (Step 604). Upon detecting the presence of a POS terminal, the card prompts the user to place a finger on the onboard fingerprint sensor. The card compares the captured fingerprint data against the previously stored non-reversible biometric template within the secure element. A successful match enables further interaction with the POS terminal, while a mismatch may prevent the card from releasing any payment credentials.

In the next step 606, the card executes transmitting account labels to the POS. In the preferred embodiment, instead of transmitting full account numbers or sensitive financial data, the card sends a set of descriptive labels associated with the tokenized payment accounts stored in the credential slots thereof. The labels can include names such as “Account A,” “Account B,” “Rewards Card,” or other user-defined identifiers.

Thereafter, the POS terminal displays account labels and receives a selection of one of the accounts (Step 608). The terminal displays the account options on the display interface thereof, enabling the user to choose the desired payment account for the transaction. The selected account is then relayed back to the card or used directly to initiate an EMV-compliant transaction using a corresponding tokenized payment credential.

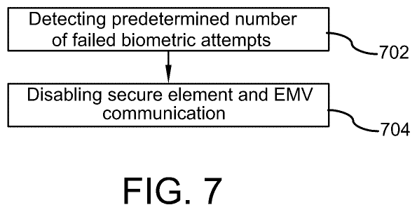

FIG. 7 illustrates an exemplary security-response process implemented by the biometric multi-account transaction card in accordance with the disclosed structure. Initially, the card apparatus 100 detects a predetermined number of failed biometric attempts (Step 702). For detection, the card 100 monitors successive fingerprint-authentication attempts performed by the user. Each unsuccessful comparison, where the captured fingerprint does not match any stored biometric templates, is incrementally counted by the microcontroller or secure element. Once the number of failed attempts reaches a predefined threshold, such as three, five, or another configurable limit, the card transitions into a protective mode to prevent further unauthorized access.

Upon reaching the threshold, the card disables the secure element and EMV communication (Step 704). In the disabled state, the secure element does not respond to credential requests, and the EMV interface is deactivated or placed in a locked state. The step prevents the release of tokenized payment credentials and inhibits any further transaction processing until the card is reset or reauthorized through an issuer-controlled mechanism.

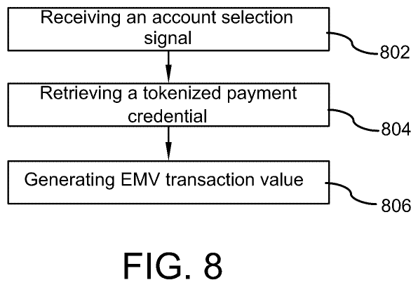

FIG. 8 illustrates a flowchart depicting a process for generating a tokenized payment credential and producing an EMV-compliant cryptogram during a transaction initiated by the biometric multi-account transaction card. Initially, the card receives an account selection signal from the point-of-sale (POS) terminal or from a pre-selected account state stored on the card (Step 802). The selected account corresponds to a particular tokenized credential stored within a credential slot of the secure element.

Then, the card retrieves a tokenized payment credential from the secure element (Step 804). The retrieved data can include a token metadata and transaction counters required for EMV processing. Thereafter, the card generates an EMV transaction value which forms the basis for dynamic authentication, maintaining that each transaction is unique and resistant to replay attacks (Step 806).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “biometric multi-account transaction card”, “multi-account transaction card”, “card apparatus”, “transaction card”, and “card” are interchangeable and refer to the biometric multi-account transaction card 100 of the present invention.

Notwithstanding the forgoing, the biometric multi-account transaction card 100 of the present invention can be of any suitable configuration as is known in the art without affecting the overall concept of the invention, provided that it accomplishes the above stated objectives. One of ordinary skill in the art will appreciate that the biometric multi-account transaction card 100 shown in the FIGS. are for illustrative purposes only, and that many other configurations of the biometric multi-account transaction card 100 are well within the scope of the present disclosure. Although the dimensions of the biometric multi-account transaction card 100 are important design parameters for user convenience, the biometric multi-account transaction card 100 can be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A biometric multi-account transaction card comprising:
a multi-factor transaction card;
a sensor;
a circuit contact module;
a secure element; and
a microcontroller;
wherein said multi-factor transaction card comprising multiple payment accounts provisioned on said multi-factor transaction card;
wherein said sensor is an embedded biometric fingerprint sensor;
wherein said biometric fingerprint sensor selected from the group consisting of a capacitive sensor, an optical sensor, and an ultrasonic sensor operable to capture a fingerprint image of a user;
wherein said circuit contact module is an integrated circuit comprising ISO/IEC 7816 and EMV specifications;
wherein said circuit contact module comprises a plurality of conductive pads configured to communicate with a point-of-sale (POS) terminal;
wherein the communication with said POS terminal is selected from the group consisting of power, data exchange, and cryptographic processing;
wherein said secure element is configured as a tamper-resistant integrated circuit to store information selected from the group consisting of biometric templates, tokenized payment credentials, and authentication keys; and
further wherein said microcontroller comprises an embedded processing unit configured to execute one or more selected from the group consisting of biometric-matching algorithms, account-selection logic, and EMV transaction protocols.

2. The biometric multi-account transaction card of claim 1 further comprising an imaging optical element, wherein said imaging optical element is an element selected from the group consisting of a miniature lens, a photodiode assembly, a camera sensor cover, and an optical window through which a sub-surface imaging module views the user.

3. The biometric multi-account transaction card of claim 2, wherein said imaging optical element is configured for a function selected from the group consisting of facial recognition, environmental light sensing, and optical detection.

4. The biometric multi-account transaction card of claim 3, wherein said secure element is implemented as one or more of the group consisting of a certified hardware security module (HSM), a secure microcontroller, and a Java Card-compliant secure IC.

5. The biometric multi-account transaction card of claim 4, wherein said multi-factor transaction card comprising a card body with a token memory bank including one or more regions of secure non-volatile storage used to hold tokenized representations of multiple financial accounts.

6. The biometric multi-account transaction card of claim 5, wherein said token memory bank comprises a plurality of independent token slots corresponding to one or more of the group consisting of credit cards, debit cards, loyalty accounts, and financial services associated with the user.

7. The biometric multi-account transaction card of claim 6, wherein said microcontroller comprises one or more selected from the group consisting of a dedicated arithmetic logic unit (ALU), a random-number generator (RNG), and a low-power processing core.

8. The biometric multi-account transaction card of claim 6 further comprising an NFC antenna, wherein said NFC antenna comprising a planar antenna structure embedded in said card body.

9. The biometric multi-account transaction card of claim 8, wherein said NFC antenna is configured to support communication selected from the group consisting of near-field communication (NFC), ISO/IEC 14443, and EMV.

10. The biometric multi-account transaction card of claim 9, wherein said NFC antenna provides wireless communication for interacting with said POS terminal.

11. The biometric multi-account transaction card of claim 10, wherein said POS terminal configured to interact with said multi-factor transaction card and comprising a housing that includes a display screen and a graphical user interface for selecting among said multiple payment accounts provisioned on said multi-factor transaction card.

12. The biometric multi-account transaction card of claim 11, wherein said POS terminal comprising a facial-recognition module selected from the group consisting of a camera, an optical sensor array, and a depth-sensing unit operable to acquire facial imagery of the user for multi-factor authentication.

13. A biometric multi-account transaction card comprising:
a multi-factor transaction card;
a sensor;
a circuit contact module;
a secure element;
a microcontroller; and
an NFC antenna;
wherein said multi-factor transaction card comprising multiple payment accounts provisioned on said multi-factor transaction card;
wherein said sensor is an embedded biometric fingerprint sensor;
wherein said biometric fingerprint sensor selected from the group consisting of a capacitive sensor, an optical sensor, and an ultrasonic sensor operable to capture a fingerprint image of a user;
wherein said circuit contact module is an integrated circuit comprising ISO/IEC 7816 and EMV specifications;
wherein said circuit contact module comprises a plurality of conductive pads configured to communicate with a point-of-sale (POS) terminal;
wherein the communication with said POS terminal is selected from the group consisting of power, data exchange, and cryptographic processing;
wherein said secure element is configured as a tamper-resistant integrated circuit to store information selected from the group consisting of biometric templates, tokenized payment credentials, and authentication keys;
wherein said microcontroller comprises an embedded processing unit configured to execute one or more selected from the group consisting of biometric-matching algorithms, account-selection logic, and EMV transaction protocols;
wherein said NFC antenna comprising a planar antenna structure embedded in said card body;
wherein said NFC antenna is configured to support communication selected from the group consisting of near-field communication (NFC), ISO/IEC 14443, and EMV; and
further wherein said NFC antenna provides wireless communication for interacting with said POS terminal.

14. The biometric multi-account transaction card of claim 13 further comprising an imaging optical element, wherein said imaging optical element is an element selected from the group consisting of a miniature lens, a photodiode assembly, a camera sensor cover, and an optical window through which a sub-surface imaging module views the user.

15. The biometric multi-account transaction card of claim 14, wherein said imaging optical element is configured for a function selected from the group consisting of facial recognition, environmental light sensing, and optical detection.

16. The biometric multi-account transaction card of claim 15, wherein said multi-factor transaction card comprising a card body with a token memory bank including one or more regions of secure non-volatile storage used to hold tokenized representations of multiple financial accounts.

17. The biometric multi-account transaction card of claim 16, wherein said token memory bank comprises a plurality of independent token slots corresponding to one or more of the group consisting of credit cards, debit cards, loyalty accounts, and financial services associated with the user.

18. The biometric multi-account transaction card of claim 17, wherein said POS terminal configured to interact with said multi-factor transaction card and comprising a housing that includes a display screen and a graphical user interface for selecting among multiple payment accounts provisioned on said multi-factor transaction card.

19. A method of using a biometric multi-account transaction card, the method comprising the steps of:
providing a multi-factor transaction card, a biometric sensor, a circuit contact module, a secure element; and a microcontroller, wherein said multi-factor transaction card comprising multiple payment accounts provisioned on said multi-factor transaction card;
initiating a payment transaction with said multi-factor transaction card at a POS terminal;
selecting said biometric sensor from the group consisting of a capacitive sensor, an optical sensor, and an ultrasonic sensor operable to capture an image of a user;
wherein said circuit contact module is an integrated circuit comprising ISO/IEC 7816 and EMV specifications;
wherein said circuit contact module comprises a plurality of conductive pads configured to communicate with a point-of-sale (POS) terminal;
selecting the communication with said POS terminal from the group consisting of power, data exchange, and cryptographic processing;
wherein said secure element is configured as a tamper-resistant integrated circuit to store information selected from the group consisting of biometric templates, tokenized payment credentials, and authentication keys;
executing with said microcontroller one or more selected from the group consisting of biometric-matching algorithms, account-selection logic, and EMV transaction protocols; and
selecting access to at least one of said multiple payment accounts provisioned on said multi-factor transaction card.

20. The method of using a biometric multi-account transaction card of claim 19 further comprising a step of authenticating the user with an imaging optical element, wherein said imaging optical element is an element selected from the group consisting of a miniature lens, a photodiode assembly, a camera sensor cover, and an optical window through which a sub-surface imaging module views the user.
